(19) United States
(12) Patent Application Publication
(10) Pub. No.: US 2007/0281503 A1
(43) Pub. Date: Dec. 6, 2007

(54) METHOD FOR REPAIRING CONDUCTIVE STRUCTURE OF CIRCUIT BOARD

(75) Inventors: Shih-Ping Hsu, Hsin-chu (TW); Chao Wen Shih, Hsin-chu (TW)

Correspondence Address: SAWYER LAW GROUP LLP, P O BOX 51418, PALO ALTO, CA, 94303, US

(73) Assignee: PHOENIX PRECISION TECHNOLOGY CORPORATION, Hsin-chu (TW)

(21) Appl. No.: 11/756,257

(22) Filed: May 31, 2007

(30) Foreign Application Priority Data
Jun. 1, 2006 (TW) 095119333

(51) Int. Cl. H01R 12/00

(52) U.S. Cl. 439/66

(57) ABSTRACT

A method for repairing a conductive structure of a circuit board is proposed. The method is implemented by performing a micro-depositing process or a micro-plating process on a surface of at least a contact pad of a circuit board without having a conductive structure formed thereon through micro-droplet or micro-electrode technique, thereby forming a conductive structure on the surface of the at least one left-out contact pad of the circuit board. As a result, the fabrication yield is increased, and extra time and costs spent on reworking the circuit board can be avoided as compared with the prior art.

### BACKGROUND OF THE INVENTION

1. Field of the Invention

The present invention relates generally to methods for repairing a conductive structure of a circuit board, and more particularly to a method for repairing a conductive structure on a surface of at least a contact pad of a circuit board that is left out without a conductive structure formed thereon through micro-droplet or micro-electrode technique.

2. Description of Related Art

With rapid development of the electronic industry, R&D efforts have long been focused on multi-functional and high-performance electronic products. Accordingly, circuit boards with high-density circuit layout for such electronic products are required. Therefore, the issue of realizing high-density circuit layout in limited area of circuit boards or substrates becomes pressing and critical.

Accordingly, multi-layered circuit boards with fine circuits and high density have been developed. Therein, conductive structures for electrically connecting circuit layers of a multi-layered circuit board is an important factor with respect to the quality of electrical connection of the circuit board.

Conventionally, conductive blind vias are used as the conductive structure for electrical connection between circuit layers of a circuit board. A dielectric layer is formed on a circuit layer of the circuit board, and the circuit layer has a plurality of contact pads formed thereon. For exposing the contact pads therefrom, a plurality of openings are formed in the dielectric layer to allow the contact pads to be electrically connected to the internal circuit layers of the circuit board through the conductive blind vias.

However, in the conventional fabrication process of a circuit board, due to certain factors such as operating conditions and equipment, the conductive blind vias may not be formed between circuit layers of the circuit board, thereby adversely affecting the electrical connection between the circuit board and semiconductor chip in subsequent packaging process. With continuous reduction of component size and growing density of circuit integration, even minor defects, such as the failure to form the required conductive blind vias, can seriously affect the quality of the electrical performance of the circuit board.

Therefore, there is a need to provide a method for repairing the conductive structure of a circuit board to eliminate the problems existing in the prior art.

### SUMMARY OF THE INVENTION

According to the above drawbacks, an objective of the present invention is to provide a method for repairing a conductive structure of a circuit board so as to increase fabrication yield of the circuit board.

Another objective of the present invention is to provide a method for repairing conductive structure of a circuit board so as to avoid extra time and costs spent on reworking the circuit board in the prior art.

In order to attain the above and other objectives, the present invention proposes a method for repairing a conductive structure of a circuit board, which comprises the steps of: providing a circuit board having a plurality of contact pads formed on at least one surface thereof, a dielectric layer formed on the surface of the circuit board, a plurality of openings formed in the dielectric layer to expose the contact pads therefrom, and a plurality of conductive structures formed on the contact pads exposed from the openings of the dielectric layer, wherein at least one of the contact pads is left out without having a conductive structure formed thereon; and performing a micro-depositing process on the surface of the at least one left-out contact pad of the circuit board via micro-droplet technique so as to form at least a second conductive structure on a surface of the at least one left-out contact pad of the circuit board.

Another method for repairing a conductive structure of a circuit board according to the present invention comprises the steps of: providing a circuit board having a plurality of contact pads formed on at least one surface thereof, a dielectric layer formed on the surface of the circuit board, a plurality of openings formed in the dielectric layer to expose the contact pads therefrom, and a plurality of conductive structures formed on the contact pads exposed from the openings of the dielectric layer, wherein at least one of the contact pads is left out without having a conductive structure formed thereon; and performing a micro-plating process on a surface of the at least one left-out contact pad via micro-electrode technique to form at least a further conductive structure on the at least one left-out contact pad of the circuit board.

For performing the micro-plating process, a part of the back end circuit of the at least one left-out contact pad is exposed and in contact with a second micro-electrode. Thus, a conductive structure is formed on the contact pad by using the contact pad as a reducing end and the micro-electrode near the contact pad as an oxidizing end in the micro-plating process.

The present invention is characterized by mainly performing a micro-depositing process or a micro-plating process on the surface of the at least one contact pad of a circuit board that is left out without having a conductive structure formed thereon via a micro-droplet or micro-electrode technique to form a conductive structure on a surface of the at least one left-out contact pad of the circuit board, thereby increasing the fabrication yield while reducing extra time and costs spent on reworking the circuit board.

### BRIEF DESCRIPTION OF DRAWINGS

FIGS. 1A to 1C are diagrams showing a method for repairing a conductive structure of a circuit board according to a first embodiment of the present invention;

FIGS. 2A to 2B are diagrams showing a method for repairing a conductive structure of a circuit board according to a second embodiment of the present invention; and

FIG. 3 is a diagram showing a method for repairing a conductive structure of a circuit board according to a third embodiment of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be made without departing from the spirit of the present invention.

### First Embodiment

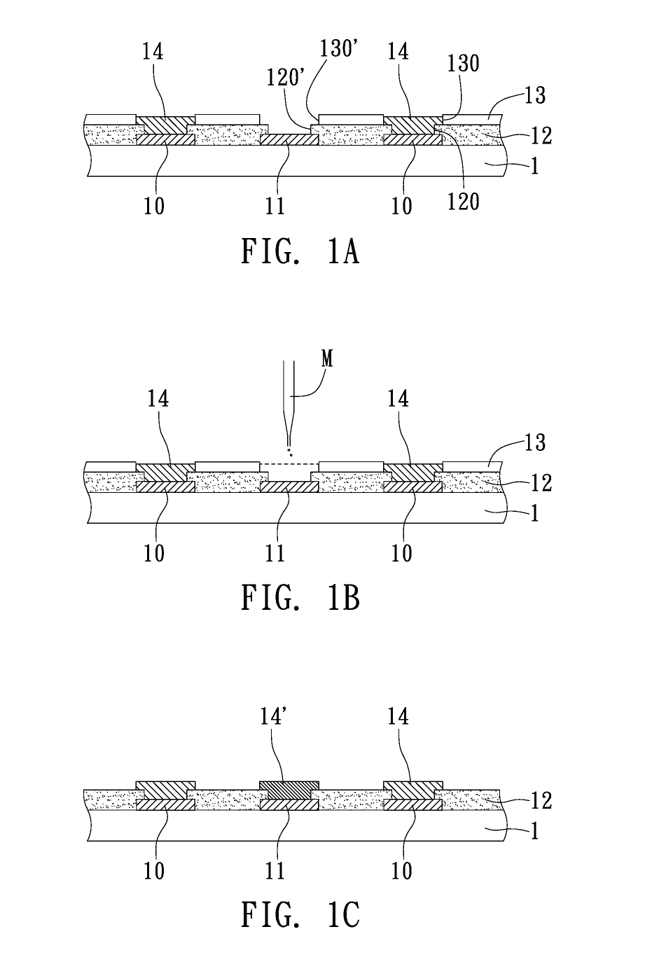

FIGS. 1A to 1C show a method for repairing a conductive structure of a circuit board according to a first embodiment of the present invention.

As shown in FIG. 1A, a circuit board 1 is provided, which has a plurality of contact pads 10, 11 formed on at least one surface thereof. A dielectric layer 12 is formed on the surface of the circuit board 1. The dielectric layer 12 is formed with a plurality of openings 120 for exposing the contact pads 10,11 therefrom. A resist layer 13 is further formed on the dielectric layer 12, which has a plurality of openings 130 formed at positions corresponding to the contact pads 10,11. A plurality of conductive structures 14 comprised of conductive blind vias and formed on the contact pads 10 are exposed from the openings 130 of the resist layer 13. However, at least one contact pad 11 is left out without having a conductive structure 14 formed thereon due to defects in the processes as skip electroplating.

As shown in FIG. 1B, a micro-depositing process is performed on the contact pad 11 via micro-droplets 2, thereby forming the conductive structure 14′ on the contact pad 11. The conductive structures 14, 14′ may be made of a material containing Pb, Sn, Ag, Cu, Au, Bi, Sb, Zn, Ni, Zr, Mg, In, Te or Ga. In addition, the conductive structures 14, 14′ may be formed by stacking one or more metal materials thereon.

As shown in FIG. 1C, the resist layer 13 is removed by a chemical solvent and the repairing process is completed.

### Second Embodiment

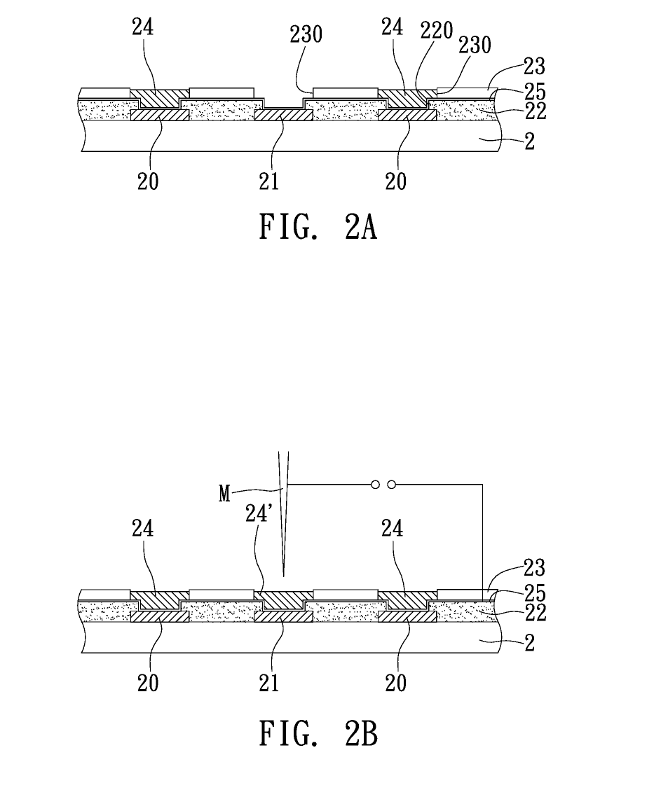

FIGS. 2A to 2C show a method for repairing a conductive structure of a circuit board according to a second embodiment of the present invention. Unlike the first embodiment, micro-electrodes are used in the present embodiment for repairing conductive structure of a circuit board instead of micro-droplets.

As shown in FIG. 2A, a circuit board 1 having a plurality of contact pads 20, 21 is provided. A dielectric layer 22 is formed on the surface of the circuit board 1 and a plurality of openings 220 are formed in the dielectric layer 22 for exposing the contact pads 20,21 therefrom. A conductive layer 15 formed on the dielectric layer 22 is exposed from the openings 220 of the dielectric layer 22. A resist layer 23 is formed on the conductive layer 25, and a plurality of openings 230 are formed in the resist layer 23 to expose therefrom the conductive layer 25 formed on the contact pads 10,11. By using the conductive layer 25 as a current conductive path, an electroplating process is performed to form a conductive structure 24 on the contact pads 20 exposed from the openings 220 of the dielectric layer 22 and the openings 230 of the resist layer 13. Due to defects in the fabrication processes, the contact pad 21 is left out without having a conductive structure formed thereon.

Referring to FIG. 2B, a micro-plating process is performed on the surface of the contact pad 21 by means of microelectrodes M to form a conductive structure 24′ on the contact pad 21. Therein, the microelectrode M is used as an oxidizing end, and the conductive layer 25 of the circuit board 1 is a reducing end. The conductive structures 24, 24′ may be made of a material containing Pb, Sn, Ag, Cu, Au, Bi, Sb, Zn, Ni, Zr, Mg, In, Te or Ga. In addition, the conductive structures 24, 24′ may be formed by stacking one or more metal materials thereon.

### Third Embodiment

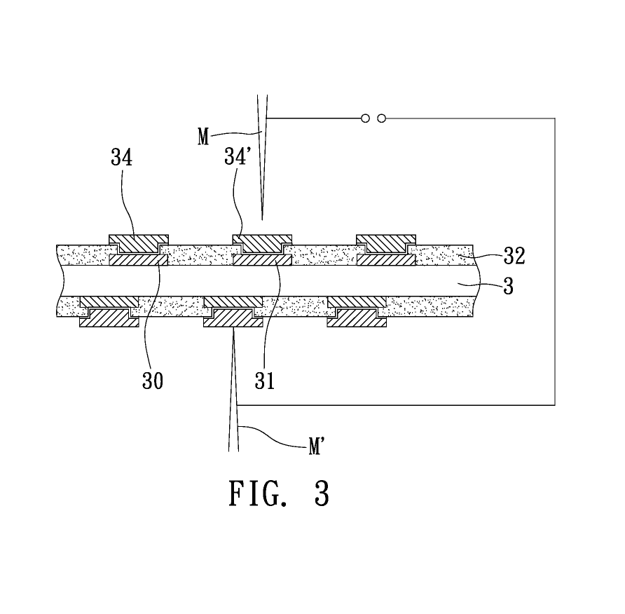

FIG. 3 shows a method for repairing a conductive structure of a circuit board according to a third embodiment of the present invention. Unlike the second embodiment, the conductive structure of the circuit board is repaired in the present embodiment by micro-electrodes after the conductive layer is removed. Therein, a part of the back end circuit of the contact pad 31 without having a conductive structure formed on is in contact with a second micro-electrode 3′. Thereby, the contact pad 31 serves as a reducing end, and the micro-electrode 3 near the contact pad 31 serves as an oxidizing end in order to perform an electroplating process locally on the contact pad 31 to form a conductive structure 34′ thereon. The conductive structures 34, 34′ may be made of a material containing Pb, Sn, Ag, Cu, Au, Bi, Sb, Zn, Ni, Zr, Mg, In, Te or Ga. In addition, the conductive structures 34, 34′ may be formed by stacking one or more metal materials thereon.

Compared with the prior art, the method for repairing a conductive structure of a circuit board of the present invention is implemented by performing a micro-depositing process or a micro-plating process on the surface of at least one contact pad of a circuit board that is left out without having a conductive structure formed thereon via micro-droplet or micro-electrode technique, thereby forming a conductive structure on the surface of the at least one left-out contact pad of the circuit board. As a result, the fabrication yield is increased, and extra time and costs spent on reworking the circuit board can be avoided.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A method for repairing a conductive structure of a circuit board, comprising the steps of:
providing a circuit board having a plurality of contact pads formed on at least one surface thereof, a dielectric layer formed on the surface of the circuit board, a plurality of openings formed in the dielectric layer to expose the contact pads therefrom, and a plurality of conductive structures formed on the contact pads exposed from the openings of the dielectric layer, wherein at least one of the contact pads is left out without having the conductive structure formed thereon; and
performing a micro-depositing process on a surface of the at least one left-out contact pad of the circuit board via micro-droplets so as to form at least a further conductive structure on the surface of the at least one left-out contact pad of the circuit board.

2. The method of claim 1, wherein a resist layer is further formed on the dielectric layer with a plurality of openings formed in the resist layer at positions corresponding to and exposing the contact pads for the conductive structures to be formed thereon.

3. The method of claim 1, wherein the conductive structures are conductive blind vias.

4. The method of claim 1, wherein the conductive structure is made of a metallic material selected from the group consisting of Pb, Sn, Ag, Cu, Au, Bi, Sb, Zn, Ni, Zr, Mg, In, Te and Ga.

5. The method of claim 1, wherein the conductive structure is formed by a single metallic material or a plurality of stacked metallic layers.

6. A method for repairing a conductive structure of a circuit board, comprising the steps of:
providing a circuit board having a plurality of contact pads formed on at least one surface thereof, a dielectric layer formed on the surface of the circuit board, a plurality of openings formed in the dielectric layer to expose the contact pads, and a plurality of conductive structures formed on the contact pads exposed from the openings of the dielectric layer, wherein at least one of the contact pads is left out without having a conductive structure formed thereon; and
performing a micro-plating process on a surface of the at least one left-out contact pad via micro-electrodes to form a conductive structure on the at least one left-out contact pad of the circuit board.

7. The method of claim 6, wherein the conductive structures are conductive blind vias.

8. The method of claim 6, wherein a resist layer is further formed on the dielectric layer and the contact pads exposed from the openings of the dielectric layer and a resist layer is then formed on the conductive layer with a plurality of openings formed therein to expose the conductive layer on the contact pads such that the conductive structures can be formed by an electroplating process via the conductive layer as a current conductive path.

9. The method of claim 8, wherein the micro-electrode acts as an oxidizing end and the conductive layer of the circuit board acts as a reducing end.

10. The method of claim 6, wherein the micro-electrode acts as an oxidizing end, while the at least one left-out contact pad acts as a reducing end.

11. The method of claim 6, wherein the conductive structure is made of a metallic material selected from the group consisting of Pb, Sn, Ag, Cu, Au, Bi, Sb, Zn, Ni, Zr, Mg, In, Te and Ga.

12. The method of claim 6, wherein the conductive structures are formed by a single metallic material or a stacking of multiple metallic materials.
